(19) United States
(12) Patent Application Publication
(10) Pub. No.: US 2022/0079319 A1
(43) Pub. Date: Mar. 17, 2022

(54) VARIABLE DOSE APPLICATOR

(71) Applicant: GlaxoSmithKline Consumer Healthcare Holdings (US) LLC, Wilmington, DE (US)

(72) Inventors: Amit SABHERWA, Warren, NJ (US); Gregory A. ORNOSKI, Warren, NJ (US)

(21) Appl. No.: 17/414,448

(22) PCT Filed: Dec. 17, 2019
(86) PCT No.: PCT/US2019/066720

§ 371 Date: Jun. 16, 2021

Related U.S. Application Data
(60) Provisional application No. 62/781,708, filed on Dec. 19, 2018.

(51) Int. Cl. A45D 34/04; G01F 11/00

(52) U.S. Cl. CPC A45D 34/04; A45D 2200/05; A45D 2200/055; G01F 11/006

(57) ABSTRACT

Aspects of the present invention are directed to a variable dose applicator. The variable dose applicator comprises a container including a collar portion, a top portion, a bottom portion, and a side wall portion, the space between the bottom portion and the side wall portion defining an interior space to hold contents of the container. The variable dose applicator may further include an actuator, the actuator being depressible in a longitudinal direction to drive the contents held in the interior space of the container out of an applicator extending from the actuator. Additionally, the actuator includes one or more dosing elements protruding horizontally from the actuator. The collar portion has a top circumferential edge containing one or more grooves of varying depth into which the one or more dosing elements can be inserted when the actuator is depressed, thereby adjusting a distance the actuator is moved in the longitudinal direction.

### TECHNOLOGY FIELD

Aspects of the present invention are directed to a variable dose applicator having a collar portion for dispensing the contents of a container to allow a user to select the amount of contents to be dispensed.

### BACKGROUND

Containers with pumps provide a hygienic and convenient way to dispense contents contained within the container. Such containers are readily used with pharmaceuticals, cosmetics, and the food industry. Typically, a user presses down on an actuator or button, which enables the pump within, and a predetermined amount of contents is dispensed.

In a conventional container, the amount of contents that is dispensed is constant every time the user presses down on the actuator because the piston travels the same distance with each pump. It is difficult for a user to manually control the distance that the piston is moved when pressing the actuator. Thus, regardless of the amount of contents that is needed by the user, the same amount is always discharged from the container. A user is not able to select and customize the amount of contents that is dispensed from the container which results in waste and an inconvenient user experience.

Containers that may allow for varied dosing are often bulky and complicated in construction. Additionally, such containers can involve many individual parts and can be expensive to manufacture resulting in an increased end cost for the user.

Based on the concerns noted above, a variable dose applicator with a simple construction that easily allows a user to select the amount of contents to be dispensed and applied directly to the intended area is highly desirable.

### SUMMARY

Aspects of the present invention are directed to a variable dose applicator comprising: a container including a collar portion, a top portion, a bottom portion, and a side wall portion, the space between the bottom portion and the side wall portion defining an interior space to store contents; and an actuator coupled with the container, the actuator being depressible in a longitudinal direction to drive the contents held in the interior space of the container out of an applicator extending from the actuator, wherein the actuator includes one or more dosing elements protruding horizontally from the actuator, and wherein the collar portion has a top circumferential edge containing one or more grooves of varying depth into which the one or more dosing elements can be inserted when the actuator is depressed, thereby adjusting a distance the actuator is moved in the longitudinal direction.

The present invention further provides that the one or more dosing elements protrude from the actuator in a direction perpendicular to the actuator. The present invention further provides that the actuator is rotatable to align the one or more dosing elements above the one or more grooves.

The present invention further provides that the container includes a shoulder. The present invention further provides that the collar portion is a hollow circular shape and is provided on the shoulder. The present invention further provides that a top end of a tube extends into the collar portion and a bottom end of the tube extends to the contents held in the interior space of the container.

The present invention further provides that the one or more grooves includes a high dose dispensing groove having a depth between about 2.0 mm and about 5.5 mm. The present invention further provides that the high dose dispensing groove has a depth of about 3.1 mm. The present invention further provides that the one or more grooves includes a low dose dispensing groove having a depth between about 0.1 mm and about 3.1 mm. The present invention further provides that the low dose dispensing groove has a depth of about 0.8 mm. The present invention further provides that the high dose in in an amount between about 0.5 mg and about 10 mg. The present invention further provides that the low dose is in an amount between about 0.5 mg and about 3 mg.

The present invention further provides that the contents stored in the interior space of the container is docosanol. The present invention further provides that the contents stored in the interior space of the container is a combination of docosanol, benzyl alcohol, light mineral oil, propylene glycol, water, sucrose distearate, sucrose stearate.

The present invention further provides that the collar portion has a thickness between about 0.5 mm and about 1.5 mm, an inner diameter between about 11.5 mm and about 13 mm, and a height between about 11.5 mm and about 13.5 mm.

### FIGURES

FIG. 1 illustrates an exploded view of a variable dose applicator of the present invention;

FIG. 2 illustrates a perspective view of a container of the present invention;

FIG. 3 illustrates a perspective view of the variable dose applicator of the present invention in a high dose resting state;

FIG. 4 illustrates a perspective view of the variable dose applicator of the present invention in a high dose dispensing state;

FIG. 5 illustrates a perspective view of the variable dose applicator of the present invention in a low dose resting state;

FIG. 6 illustrates a perspective view of the variable dose applicator of the present invention in a low dose dispensing state;

FIG. 7 illustrates a perspective view of the variable dose applicator of the present invention in a locked state;

FIG. 8 illustrates a top view of the variable dose applicator of the present invention in a locked state.

### DETAILED DESCRIPTION

Aspects of the present invention are directed to a variable dose applicator having one or more dosing elements on an actuator, a pump for dispensing a contents of the variable dose applicator via an applicator, and a collar portion to allow a user to select the amount of contents to be dispensed and applied directly to the intended area. The collar portion of the variable dose applicator is equipped with grooves of varying depth so that the operating distance to which the actuator is moved to discharge the contents can be adjusted to control the amount of contents that is discharged without changing the functionality of the inner pump. The greater the depth of the groove, the lower the actuator can be depressed by a user resulting in more contents being dispensed from the container. A user can position grooves of a desired depth under the dosing elements, thereby when the actuator is depressed, the groove creates a mechanical stop preventing the actuator from being depressed further than the intended amount. Thus, a user can select the amount of contents to be dispensed from the container.

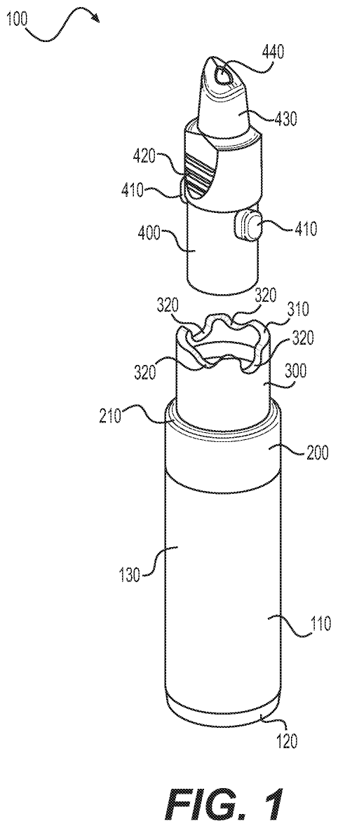

The variable dose applicator 100 of the present invention is generally depicted in FIG. 1. Specifically, FIG. 1 illustrates an exploded view of the variable dose applicator 100 according to the present invention. As shown in FIG. 1, the variable dose applicator 100 includes a container 110 having a collar portion 300, an actuator 400 having one or more dosing elements 410, and an applicator 430 provided on the actuator 400. The container 110 further includes a top portion 140, a side wall portion 130, a bottom portion 120, and a shoulder 210. The side wall portion 130 extends upwards from the bottom portion 120 towards the top portion 140 to define an interior space of the container 110. The container 110 may store contents within the interior space. The collar portion 300 is provided on the shoulder 210 of the container 110. A tube may be provided such that a top end of the tube extends into the collar portion 300 and a bottom end of the tube extends into the container 110 to the contents held in the interior space.

In an embodiment, the container 110 may consist of two separate pieces wherein a cap portion 200 may be a separate removable piece which may be snap fitted or friction fitted to the top portion 140 to create a permanent and airtight seal. In another embodiment, the cap portion 200 may be formed integrally with the rest of the container 110 so that the container 110 constitutes a single continuous piece.

The bottom of the collar portion 300 of the container 110 is provided on the top surface of the shoulder 210. The collar portion 300 comprises one or more grooves 320 of varying depth. In a preferred embodiment, the collar portion 300 may be formed integrally with the cap portion 200 and the cap portion 200 and the collar portion 300 may be a singular separate piece from the remainder of the container 110. In another embodiment, the collar portion 300 may be continuous with the container 110 and integrally formed with the container 110 so that the container 110, the collar portion 300, and the cap portion 200 all constitute one single piece. In another embodiment the collar 300 may be a separate piece from the remainder of the container 110. In such an embodiment, the collar portion 300 may be attached to the shoulder 210 during assembly of the variable dose applicator 100. In another embodiment, the collar potion 300 may have a vertical slit extending from a top circumferential edge 310 of the collar portion 300 to a bottom edge. In such an embodiment, the vertical slit can be stretched so that the collar portion 300 can be snapped onto the variable dose applicator 100 at any point during or after assembly.

The actuator 400 is coupled with the container 110 and is depressible in a longitudinal direction. In a preferred embodiment, the actuator 400 may be adapted to fit in the inner hollow portion of the collar portion 300. In another embodiment, the actuator 400 may be provided so as to be external to the collar portion 300. A tube extends upwards into the actuator 400 to facilitate the movement of the contents out of the container 110 through the applicator 430 when the actuator 400 is depressed. In an embodiment, the actuator 400 may be affix to the inner surface of the collar portion 300. In another embodiment, the actuator 400 may be attached to the top of the tube, and a gap may be present between the actuator 400 and the inner surface of the collar portion 300 extending around the entirety of the actuator 400. In a preferred embodiment, the actuator 400 can be rotated by a user about a longitudinal axis in either direction while the collar portion 300 and the other components of the variable dose applicator 100 remain stationary. The actuator 400 includes one or more finger grips 420 provided on the actuator. In a preferred embodiment, the actuator includes 2 finger grips 420 provided on opposing sides of the actuator 400 to aid a user in rotating the actuator 400. In another embodiment, the actuator 400 may be stationary in a rotational direction.

The actuator 400 may be depressed in a longitudinal direction by a user to engage the internal pump and drive the movement of the contents out of the container 110 through an orifice 440 provided on the applicator 430. The actuator 400 further includes one or more dosing elements 410 protruding from the actuator 400. In a preferred embodiment, the dosing elements 410 protrude from the actuator 400 in a direction perpendicular to the actuator 400. In a preferred embodiment, the actuator includes two dosing elements 410 provided on opposing sides of the actuator 400. The dosing elements 410 are provided on the actuator 400 at a position below in finger grips 420 and above the collar portion 300 of the container 110. In a preferred embodiment, the dosing elements 410 are an elliptical shape. The length of the dosing elements may be between about 3.0 mm and about 8.0 mm. In a preferred embodiment, the length of the dosing elements is about 5.5 mm. The dosing elements 410 may have a width between about 2.0 mm and about 5 mm. In a preferred embodiment, the dosing elements 410 have a width of about 3.75 mm. The dosing elements 410 may have a thickness between about 1.0 mm and about 4.0 mm. In a preferred embodiment, the thickness of the dosing elements 410 is about 2.5 mm.

The actuator 400 further includes an applicator 430. In a preferred embodiment, the applicator 430 extends vertically from the actuator 400. In a preferred embodiment, the applicator 430 has a soft tip including an orifice 440 from which contents held in the interior space of the container 110 can be dispensed. The applicator 430 allows a user to apply the contents dispensed directly from the applicator to the intended area. This direct application allows the user to obtain quick and convenient application of the contents without contamination or waste. The front of the applicator 430 at the lowest point to the back of the applicator at the highest point has an angle between about 20° and about 40° relative to the horizontal axis. In a preferred embodiment, the angle of the applicator 430 from the front of the applicator 430 at the lowest point to the back of the applicator 430 at the highest point is about 31° relative to the horizontal axis. This angle creates a curvature on the applicator 430 that is convenient for application of the contents to the user's lip or other areas. The applicator 430 from the top tip of the applicator 430 downwards along the side of the applicator 430 has an angle between about 15° and about 35° relative to the horizontal axis. In a preferred embodiment, the angle of the applicator 430 from the top tip of the applicator 430 downwards along the side of the applicator 430 is about 25° relative to the horizontal axis. This creates a fine tip on the applicator 430 which allows for precise application of the contents to the intended area.

In a preferred embodiment, the collar portion 300 may be stationary, and the actuator 400 may be rotated by a user in either direction to move the position of the dosing elements 410 to be above the desired grooves 320 provided on the collar 300 in order to dispense the desired amount of product from the container 110 via the applicator 430. When the actuator 400 is depressed by a user, the dosing elements 410 abut the bottom surface of a selected grooves 320. The contact of the dosing elements 410 with the bottom surface of the selected grooves 320 creates a mechanical stop preventing the actuator 400 from being depressed further, thereby controlling the distance that the actuator 400 moves and controlling the amount of contents that is dispensed from the applicator 440. In another embodiment, the actuator 400 may be stationary in a rotational direction, and the collar 300 portion may be rotated by a user in either direction to place the selected grooves 320 under the dosing elements 410.

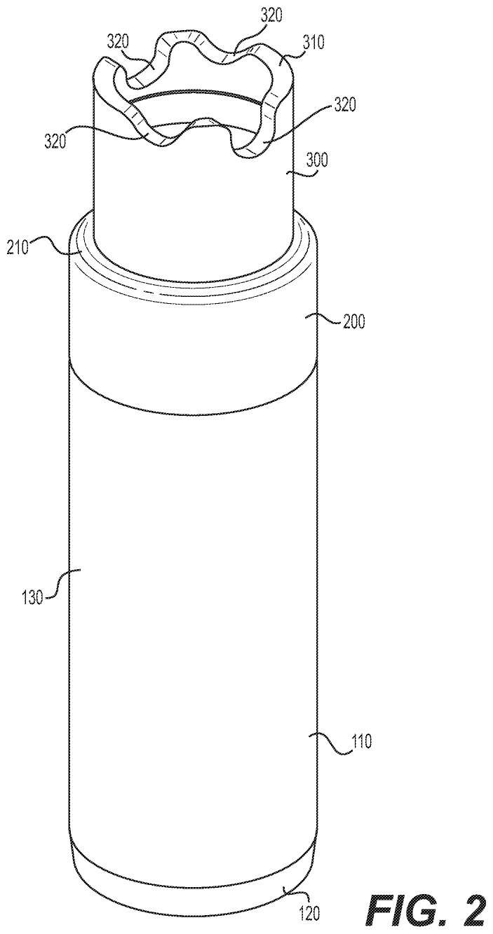

FIG. 2 illustrates a perspective view of the container 110 having a collar portion 300 according to the present invention. As depicted in FIG. 2, the col lar portion 300 may be a hollow cylindrical shape with one or more grooves 320 of varying depth provided on the top circumferential edge 310 and extending in a downward direction towards the bottom of the collar portion 300. The shape of the collar portion 300 is not limited, and the collar portion 300 can be any suitable shape. In a preferred embodiment, the collar portion 300 includes two corresponding grooves of the same depth provided on opposing sides of the collar portion in order to accommodate two dosing elements 410 provided on opposing sides of the actuator 400. Two dosing elements 410 fitting into two corresponding grooves 320 of the collar portion 300 securely fixes the actuator into the correct position in order to dispense the desired amount of contents.

The collar portion 300 has a thickness between about 0.5 mm and about 1.5 mm. In a preferred embodiment, the thickness of the collar portion 300 is about 1 mm. The inner diameter of the collar portion 300 is between about 10.5 mm and about 15 mm. In a preferred embodiment, the inner diameter of the collar portion 300 is about 12.2 mm. The height of the collar portion 300 is between about 11.5 mm and about 16.5 mm. In a preferred embodiment, the collar portion has a height of about 12.7 mm.

In an embodiment, the collar portion 300 may have 1, 3, 4, 5, or 6 grooves into which the one or more dosing elements 410 can be inserted when the actuator 400 is depressed. In a preferred embodiment, the collar portion 300 has 4 grooves including two sets of 2 corresponding grooves, each set having grooves of the same depth as one another and being provided opposite of one another. The grooves 320 may have a generally U shape; however, the shape of the grooves 320 is not limited. The grooves 320 may be any suitable shape that can accommodate the curvature of the dosing elements 410 and provide a mechanical stop for the longitudinal movement of the actuator 400 by abutting the dosing elements 410. In an embodiment, the one or more grooves 320 may allow the actuator to travel between 0% and 100% of the actuator's total operating distance. In a preferred embodiment, the one or more grooves 320 of the collar portion allows the actuator to be depressed to about 0% of the actuator's total operating distance, about 25% of the actuator's total operating distance, about 50% of the actuator's total operating distance, about 75% of the actuator's total operating distance, about 100% of actuator's total operating distance, or any combination thereof.

The grooves 320 may be provided at any point around the collar portion 300. In an embodiment, the grooves 320 may be positioned so that a rotation of between about 25° and about 180° will move the position of the dosing elements 410 from over one set of grooves 320 to over another set of grooves 320. In a preferred embodiment, a rotation of about 120° will move the position of the dosing elements 410 from over one set of grooves 320 to over the other set of grooves 320. In an embodiment, the grooves 320 may be positioned so that a rotation of between about 25° and about 90° will move the position of the dosing elements 410 from over any set of grooves 320 to a portion of the top circumferential edge 310 of the collar portion 300 not having a groove 320. In a preferred embodiment, a rotation of about 60° will move the position of the dosing elements 410 from over any set of grooves 320 to a portion of the top circumferential edge 310 of the collar portion 300 not having a groove 320. This movement would lock the variable dose applicator 100.

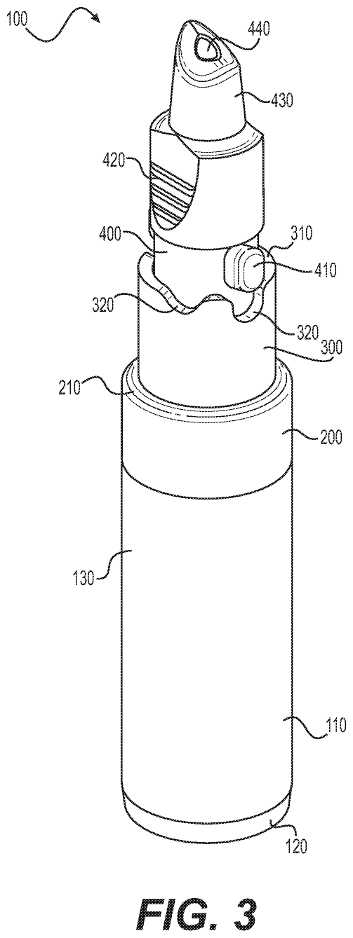

FIG. 3 illustrates a perspective view of the variable dose applicator 100 according to the present invention in a high dose resting state. In a high dose resting state, the dosing elements 410 are positioned above grooves 320 which allows a high dose of contents to be dispensed. In a preferred embodiment, two dosing elements 410 provided on opposing sides of the actuator 400 are positioned over two grooves 320 of the same depth provided on opposing sides of collar portion 300 that allow for a high dose of contents to be dispensed. In a preferred embodiment, a user can rotate the actuator 400 in order to position the dosing elements 410 in the high dose resting state. In another embodiment, a user can rotate the collar portion 300 so as to position the collar portion 300 in the high dose resting state. In this state, the variable dose applicator 100 is ready for use and when in use, a high dose of the contents will be dispensed. A high dose may be in an amount between about 0.5 mg and about 10 mg. In a preferred embodiment, the high dose is equal to about 4 mg.

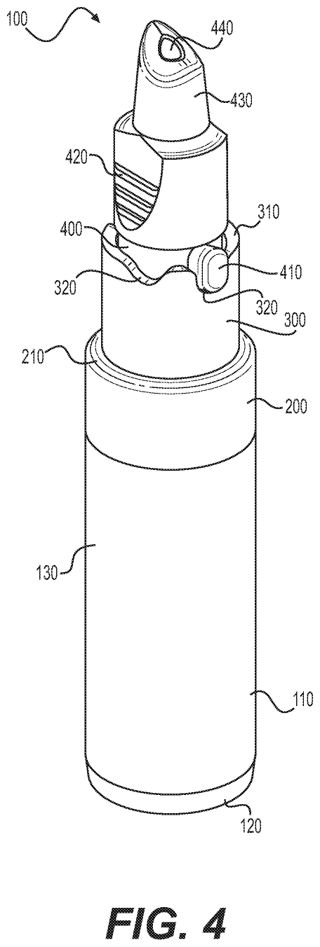

FIG. 4 illustrates a perspective view of the variable dose applicator 100 in accordance with the present invention. In particular, the variable dose applicator 100 in FIG. 4 is in a high dose dispensing state. In this state, the actuator 400 is depressed by a user and contents is discharged from the container 110 through the applicator 430 in an amount equivalent to a high dose. While being depressed, the dosing elements 410 abut the bottom surfaces of the corresponding grooves 320 so that the actuator 410 can be readily depressed an appropriate amount by a user. The larger the depth of the grooves 320, the more product can be dispensed from the container 110 via the applicator 430. In an embodiment, the grooves of the high dose dispensing state may have a depth between about 2.0 mm and about 4.5 mm. In a preferred embodiment, the grooves of the high dose dispensing state have a depth of about 3.1 mm.

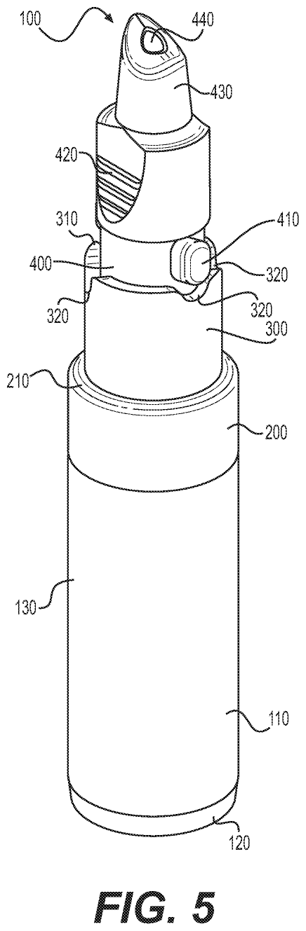

FIG. 5 illustrates a perspective view of the variable dose applicator 100 in accordance with the present invention. FIG. 5 depicts the variable dose applicator 100 in a low dose resting state. In a low dose resting state, the dosing elements 410 of the actuator 400 are positioned above grooves 320 which allows for a low dose of contents to be dispensed. In a preferred embodiment, two dosing elements 410 provided on opposing sides of the actuator 400 are positioned over two grooves 320 provided on opposing sides of collar portion 300 that allow for a low dose of contents to be dispensed. A low dose may be in an amount between about 0.5 mg and about 3 mg. In a preferred embodiment, the low dose is equal to about 2.5 mg.

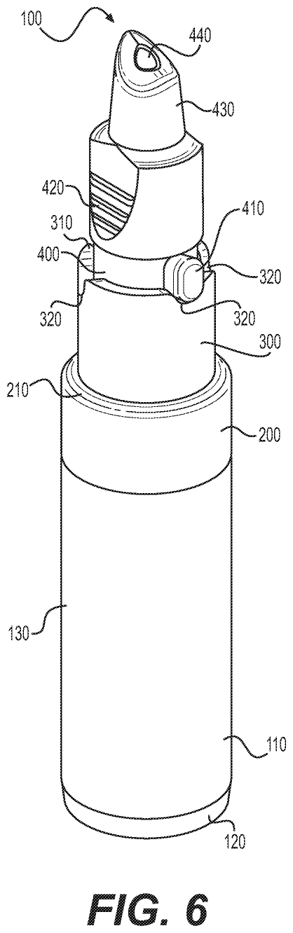

FIG. 6 illustrates a perspective view of the variable dose applicator 100 in a low dose dispensing state. In this state, the actuator 400 is depressed by a user and product is discharged from the container 110 via the applicator 430 in an amount equivalent to a low dose. While being depressed, the dosing elements 410 of the actuator 400 abut the bottom surfaces of the corresponding grooves 320 and the actuator 400 is prevented from being depressed fully; thus, dispensing a lower dose of contents as compared to the high dose dispensing state. In an embodiment, the grooves of the low dose dispensing state may have a depth between about 0.1 mm to about 3.1 mm. In a preferred embodiment, the grooves of the low dose dispensing state have a depth of about 0.8 mm.

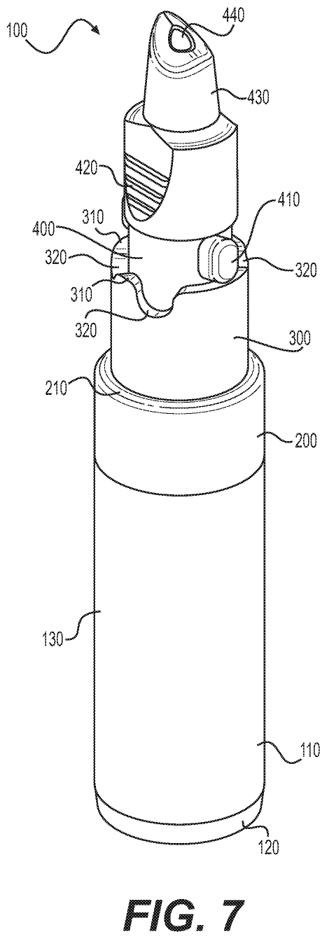

FIG. 7 is a perspective view illustrating the variable dose applicator 100 according to the present invention in a locked state. When the variable dose applicator 100 is not in use, it may be locked to avoid accidentally discharging any contents. In a locked state, the dosing elements 410 may be positioned so as to extend over a top circumferential edge 310 of the collar portion 300. In this position, the dosing elements 410 abut the top circumferential edge 310 and the actuator 400 cannot be depressed. All vertical movement of the actuator 400 is mechanically stopped by the top circumferential edge 310 when the variable dose applicator 100 is in the locked state. In a preferred embodiment, a user can rotate the actuator 400 so that the dosing elements 410 may be positioned over the top circumferential edge 310 of the collar portion 300 at any point not having a groove 320 in order to position the variable dose applicator in a locked state. In another embodiment, the variable dose applicator 100 can be placed in the locked state by rotating the collar portion 300 so that a portion of a top circumferential edge 310 of the collar portion 300 not having a groove 320 is positioned under the dosing elements 410.

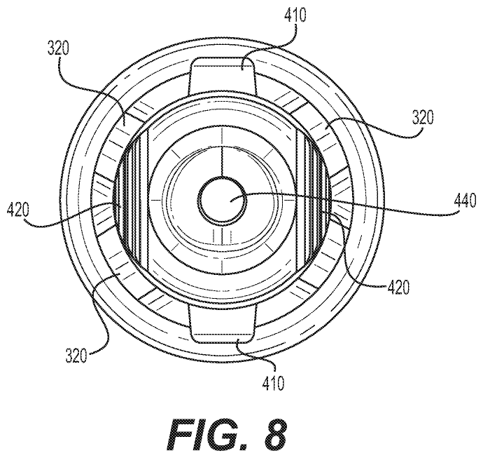

FIG. 8 is a top view of the variable dose applicator 100 according to the present invention in a locked state. In a preferred embodiment, there are two dosing elements 410 provided on opposing sides of the actuator 400; thus, when the actuator 400 is rotated by a user, the two opposing dosing elements 410 move together. In a locked state as depicted in FIG. 8, the two dosing elements 410 are moved so as to be placed over a portion of the top circumferential edge 310 of the collar portion 300 not having a groove 320.

The contents provided within the interior space of the container 110 may be any compound or composition that can be used to treat and/or prevent cold sores/fever blisters, cleanse the skin, provide pain relief, or provide overall health and wellness benefits to the user. Non-limiting examples of the contents may include pharmaceutical active ingredients including over the counter actives, behind the counter actives, prescription actives, and any combination thereof.

In an embodiment, the contents may be docosanol. In another embodiment, the contents may include a combination of docosanol, benzyl alcohol, light mineral oil, propylene glycol, purified water, sucrose distearate, and sucrose stearate.

In another embodiment, the contents may be acyclovir. In another embodiment, the contents may be a combination of acyclovir and polyethylene glycol. In another embodiment, the contents may be a combination of acyclovir, cetostearyl alcohol, mineral oil, poloxamer 407, propylene glycol, sodium lauryl sulfate, water and white petrolatum. In another embodiment, the contents may be a combination of acyclovir, hydrocortisone, liquid paraffin, white soft paraffin, isopropyl myristate, sodium lauryl sulfate, cetostearyl alcohol, poloxamer 188, propylene glycol, citric acid monohydrate, sodium hydroxide, sodium hydroxide or hydrochloric acid, and purified water. In another embodiment, the contents may be a combination of acyclovir, propylene glycol, white soft paraffin, cetostearyl alcohol, liquid paraffin, arlacel 165, poloxamer 407, dimeticone 20, sodium laurilsulfate, and purified water.

In another embodiment, the contents may be diclofenac. In another embodiment, the contents may be a combination of diclofenac, butylhydroxytoluene, carbomers, cocoyl caprylocaprate, diethylamine, isopropyl alcohol, liquid paraffin, macrogol, cetostostearyl ether, oleyl alcohol, propylene glycol, perfume eucalyptus sting, and water. In another embodiment, the contents can include a combination of diclofenac aqua, caprylic/capric triglyceride, butyrospermum, parki butter, glycerin, xylitol, 1,2-hexanediol, pentylene glycol, panthenol, behenic acid, hydrogenated lecithin acetamide MEA, palmitamide MEA, polyacrylate crosspolymer-6, caprylhydroxamic acid, acrylates/C10-30 alkyl acrylate crosspolymer, oryza sativa, cera, squalane, sodium hydroxide, t-butyl alcohol, and ceramide 3. In another embodiment, the contents may be a combination of diclofenac, carbomer homopolymer Type C, cocoyl caprylocaprate, fragrance, isopropyl alcohol, mineral oil, polyoxyl 20 cetostearyl ether, propylene glycol, purified water, and a strong ammonia solution.

In another embodiment, the contents may include penciclovir. In another embodiment, the contents may include benzalkonium chloride. In another embodiment, the contents may include lysine. In another embodiment, the contents may include pramoxine HCl. In another embodiment, the contents may include benzocaine. In another embodiment, the contents may include lidocaine. In another embodiment, the contents may include menthol. In another embodiment, the contents may include camphor. In another embodiment, the contents may include dimethicone. In another embodiment, the contents may include zinc oxide. In another embodiment, the contents may include petrolatum.

The variable dose applicator 100 may further include a cap to protect the applicator from contamination when not in use. In an embodiment, the cap may be a separate removable piece that can be fitted on top of the applicator 430. In another embodiment, the cap may be a flip cap attached to a portion of the variable dose applicator 100 and capable of being flipped closed over the applicator 430 when not in use and flipped open by a user when in use.

The variable dose applicator 100 of the present invention may be compatible with any pump or spray device, including, but not limited to airless pumps. In an airless pump of the present invention, depressing the actuator 400 creates a vacuum inside of the pump. Thus, when an internal valve opens, the contents flow into the pump and out of the applicator. As the contents is dispensed, air enters the bottom of the variable dose applicator 100 and helps advance a piston upwards to offset the vacuum.

The collar portion 300 of the present invention may be made from any suitable material. Non-limiting examples for suitable materials for the collar portion include, but are not limited to, aluminum, brass, chrome, polyethylene, and polypropylene, or any combination thereof. In an embodiment the collar portion 300 is made from a combination of polyethylene, and polypropylene.

1. A variable dose applicator comprising:
a container including a collar portion, a top portion, a bottom portion, and a side wall portion, the space between the bottom portion and the side wall portion defining an interior space to store contents; and
an actuator coupled with the container, the actuator being depressible in a longitudinal direction to drive the contents held in the interior space of the container out of an applicator extending from the actuator,
wherein the actuator includes one or more dosing elements protruding horizontally from the actuator, and
wherein the collar portion has a top circumferential edge containing one or more grooves of varying depth into which the one or more dosing elements can be inserted when the actuator is depressed, thereby adjusting a distance the actuator is moved in the longitudinal direction.

2. The variable dose applicator according to claim 1, wherein the one or more dosing elements protrude from the actuator in a direction perpendicular to the actuator.

3. The variable dose applicator according to claim 1, wherein the actuator is rotatable to align the one or more dosing elements above the one or more grooves.

4. The variable dose applicator according to claim 1, wherein the container includes a shoulder.

5. The variable dose applicator according to claim 4, wherein the collar portion is a hollow circular shape and is provided on the shoulder.

6. The variable dose applicator according to claim 1, wherein a top end of a tube extends into the collar portion and a bottom end of the tube extends to the contents held in the interior space of the container.

7. The variable dose applicator according to claim 1, wherein the one or more grooves includes a high dose dispensing groove having a depth between about 2.0 mm and about 5.5 mm.

8. The variable dose applicator according to claim 7, wherein the high dose dispensing groove has a depth of about 3.1 mm.

9. The variable dose applicator according to claim 1, wherein the one or more grooves includes a low dose dispensing groove having a depth between about 0.1 mm and about 3.1 mm.

10. The variable dose applicator according to claim 9, wherein the low dose dispensing groove has a depth of about 0.8 mm.

11. The variable dose applicator according to claim 7, wherein a high dose is in an amount between about 0.5 mg and about 10 mg.

12. The variable dose applicator according to claim 9, wherein a low dose is in an amount between about 0.5 mg and about 3 mg.

13. The variable dose applicator according to claim 1, wherein the contents stored in the interior space of the container is docosanol.

14. The variable dose applicator according to claim 13, wherein the contents stored in the interior space of the container is a combination of docosanol, benzyl alcohol, light mineral oil, propylene glycol, water, sucrose distearate, sucrose stearate.

15. The variable dose applicator according to claim 1, wherein the collar portion has a thickness between about 0.5 mm and about 1.5 mm, an inner diameter between about 10.5 mm and about 15 mm, and a height between about 11.5 mm and about 16.5 mm.
